(19) United States
(12) Patent Application Publication
(10) Pub. No.: US 2026/0109120 A1
(43) Pub. Date: Apr. 23, 2026

(54) RELATING TO LENSES

(71) Applicant: TOBII AB, DANDERYD (SE)

(72) Inventors: LUTZ KÖRNER, ZÜRICH (CH); MARCIN KRAJEWSKI, ZÜRICH (CH); DANIEL PIOTROWSKI, ZÜRICH (CH)

(21) Appl. No.: 19/069,356

(22) Filed: Mar. 4, 2025

Related U.S. Application Data
(62) Division of application No. 17/581,230, filed on Jan. 21, 2022, now abandoned.

(51) Int. Cl. B29D 11/00; B29C 33/38; B29C 39/02; B29C 39/10; B29C 39/26; B29K 105/00; B29L 11/00; G02B 1/12

(52) U.S. Cl. CPC B29D 11/00567; B29C 33/38; B29C 39/026; B29C 39/10; B29C 39/26; G02B 1/12; B29K 2105/0002; B29L 2011/0016

(57) ABSTRACT

A method of spacing an object from a mould for the formation of a multi-layered polymer. The method comprises: attaching at least one spacer to the object; attaching the at least one spacer to the mould; and adding material to the mould to form the multi-layered polymer.

### CROSS-REFERENCES TO RELATED APPLICATIONS

This application claims priority to U.S. Provisional Patent Application No. 63/139,936, filed 21 Jan. 2021, and is hereby incorporated by reference in its entirety.

### TECHNICAL FIELD

The present invention relates to improvements in the manufacture of lenses formed using a combination of a monomer and an object. The object may be a foil, a lens, a thin display, or any other such object. More specifically, it relates to lenses whereby the monomer material is cast around the object.

### BACKGROUND ART

Lens formation can be a complicated process. This is especially the case where lenses are formed in a layered manner using a film or foil, such as PMMA, and a cast lens material, such as a UV-curable monomer. Cast lenses with embedded films can be produced applying a well-known method described hereafter. Details of the method described in the background section will be known to the skilled person, and thus the description is limited to a general overview of the process. Such processes have many drawbacks, which the present application seeks to overcome.

A foil is provided, the foil having a curved surface. The foil may be formed of many different materials, such as TAC, PC, PA, PMMA or PET. The foil is then placed on a holder in order to allow the positioning of the foil relative to a mould. The mould is made up of two parts, a front mould and a back mould.

It is required to space the foil accurately with respect to one or both of the moulds. For ease of explanation, it will be assumed for the present example that the foil is being positioned relative to the front mould. Attachment dots are therefore used to hold the foil static relative to the mould. These attachment dots, typically of an adhesive or curable compound, are placed on the foil, and are then brought into contact with the front mould, with the foil the desired distance from the front mould and the attachment dots in contact with the front mould. There are a variety of options as to how to correctly position the foil, but one example is that the foil may include a flat portion that surrounds the curved portion of the foil, and the flat portion is brought into contact with a corresponding portion of the front mould. The attachment dots are then allowed to solidify, either by setting of the adhesive or by curing of the curable compound.

Once the attachment dots are solid and holding the foil in place, the holder can be removed and the back mould can be brought into position opposing the front mould and forming a space between the foil and the back mould. The front mould and back mould are then connected around their circumferences to form a mould cavity within which is positioned the foil. A curable monomer is then added into the mould cavity to cast the lens. Once in position, the monomer can be cured, forming the multi-layered lens. Removal of the lens from the mould can then be performed in any well-known way.

### STATEMENTS OF INVENTION

According to a first aspect, there is provided a method of spacing on object from a mould, for the formation of a multi-layered polymer, comprising:
attaching at least one spacer to the object;
attaching the at least one spacer to the mould; and
adding monomer to the mould; and
curing the monomer to form the multi-layered polymer.

This provides an improved method for ensuring that an object is correctly spaced from a mould, during a manufacturing process. As will be clear from the detailed description below, the order of the steps of attaching the spacer to the object and attaching the spacer to the mould are immaterial to the operation of the invention and therefore their order in the claim is not intended to be limiting. The use of spacers over attachment dots also removes the requirement for the use of a precise spacing machine, as dots must be custom-produced for each unit, whilst spacers may be mass-produced.

The object may for example be a foil, a lens, a display (in particular a thin display), or any other similar such object.

The object may be received within one or more notches or recesses in the at least one spacer.

The at least one spacer may include a protrusion onto which the object is received. The object may be secured to the at least one spacer by deforming the protrusion once the object is received on the at least one spacer.

The object may be secured to the spacer. For example, adhesive, spot welding, a fastening device such as a screw, or other such means may be used.

The at least one spacer may be secured to the mould. For example, adhesive, spot welding, a fastening device such as a screw, application of a vacuum, or other such means may be used.

The step of curing the monomer may be achieved by the application of UV radiation or by a thermal curing process.

The method may further comprise the step of removing the at least one spacer after curing the monomer.

Alternatively, the at least one spacer may be retained as a part of the multi-layer polymer.

The at least one spacer may be seated around the mould. The at least one spacer may include a recess or abutment into or against which the mould may be received.

According to a second aspect, there is provided a system for the formation of a multi-layered polymer, the system comprising:
a spacer configured to receive an object and hold it in a fixed position relative to a mould;
wherein the mould is configured to receive a monomer around the object, for the creation of the multi-layered polymer.

The object may comprise one of a foil, a lens, a display, or other similar object.

The object may be received within one or more notches or recesses in the at least one spacer.

The spacer may include a protrusion onto which the object is received.

The object may be secured to the at least one spacer by deforming the protrusion once the object is received on the at least one spacer.

The object may be secured to the at least one spacer, for example by adhesive, spot welding, a fastening device, application of a vacuum, or other such means.

The at least one spacer may be seated around the mould. The at least one spacer may include a recess or abutment into or against which the mould may be received.

### BRIEF DESCRIPTION OF THE DRAWINGS

Specific embodiments will now be described in detail with reference to the accompanying drawings, in which:

FIG. 1 is a schematic view of an assembly for spacing foil from a mould;

FIG. 2 is a flow chart of a method of spacing foil from a mould;

FIG. 3 is a flow chart of a further method of spacing foil from a mould;

FIGS. 4 and 5 are schematic views of a further assembly for spacing foil from a mould; and

FIG. 6 is a schematic view of a further assembly for spacing foil from a mould.

### DETAILED DESCRIPTION

When manufacturing a lens using foil and a second material, such as a monomer, bonded to the foil, it is necessary to be able to space the foil from a mould before the monomer is filled in the mould cavity. One example of a suitable process to space the foil from a mould is:
1. Adhesive material is dispensed on the foil
2. The foil is placed at the desired distance from a mould with the adhesive material wetting both the mould and the foil
3. The adhesive material is cured, generally by application of a UV light source

This three-step process results in the foil being held at the desired distance from the mould while the monomer is filled in the mould cavity to create the lens. The adhesive material may be dispensed and hardened in a stepwise manner, with alternate steps of dispensing and hardening. This will be achieved in a similar way to described in the background of the present specification. However, rather than using a single adhesive dot in each position between the foil and the mould, each attachment dot may be cured and then an additional attachment dot deposited on top of a cured attachment dot, to allow greater heights to be achieved.

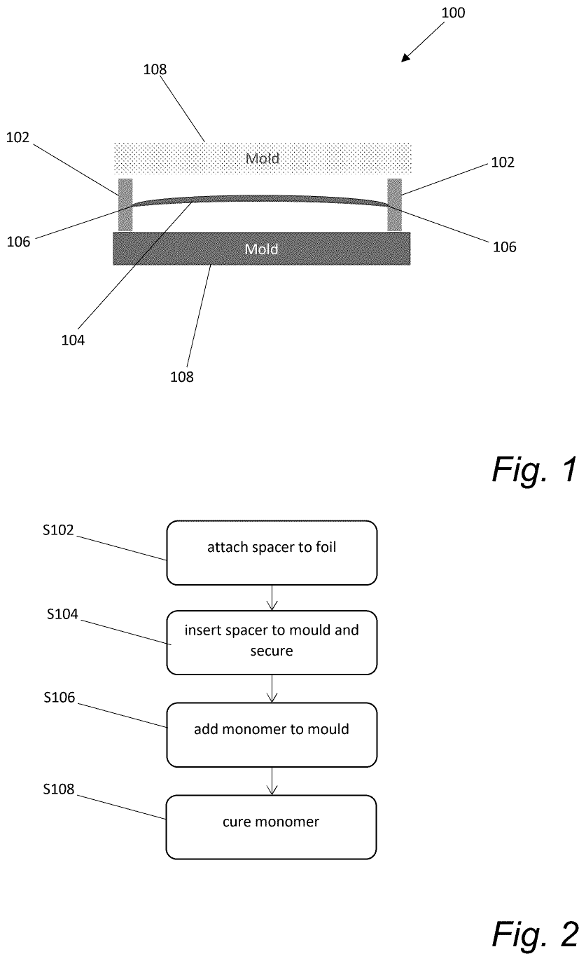

As an alternative method of spacing the foil, a method is proposed as described below and depicted in FIGS. 1 to 6.

In a first embodiment 100, described in FIGS. 1 and 2, rather than using a dispensed adhesive material, one or more spacers 102 are first attached S102 to the foil 104. The spacers 102 may be attached to the foil 104 using notches 106, into which the foil 104 is received. The spacer or spacers 106 may also be secured to the foil 104, for example using an adhesive, point welding, or another such means. The spacers 102 are then inserted S104 into the mould or moulds 108, and may be attached to the mould or moulds 108. Example methods of attaching the spacers 106 to the moulds 108 include adhesive or the application of a vacuum. Once in position, a monomer may be inserted S106 within the mould cavity to form the lens, with the foil being held in place by the spacer(s). The monomer will then be cured S108, generally by the application of UV light or by an increase in temperature (thermal curing), depending on the properties of the monomer(s). A polymer sample enclosing the sample foil will then be able to be extracted from the mould. The spacers may then be removed. In some embodiments, the spacers may be retained as a part of the finished product.

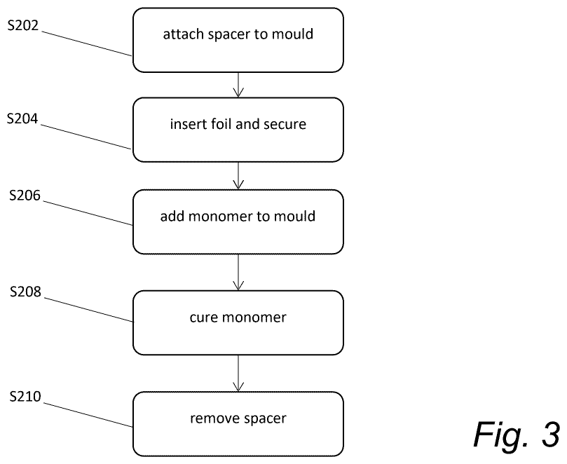

In some embodiments, as shown in FIG. 3, rather than first securing the foil to the spacer and then attaching the spacer and foil to the mould, the spacer may be attached S202 to the mould and then the foil may be attached S204 to the spacer. Hence, it is apparent that the order of steps is not necessarily intrinsic to the disclosed method. In this method, the monomer is then added S206 and cured S208, as in FIG. 2. FIG. 3 also has an additional step of removing the spacer S210. This may be included in any embodiment, where desired. However, in some embodiments, the spacer or spacers may be retained with the finished polymer product.

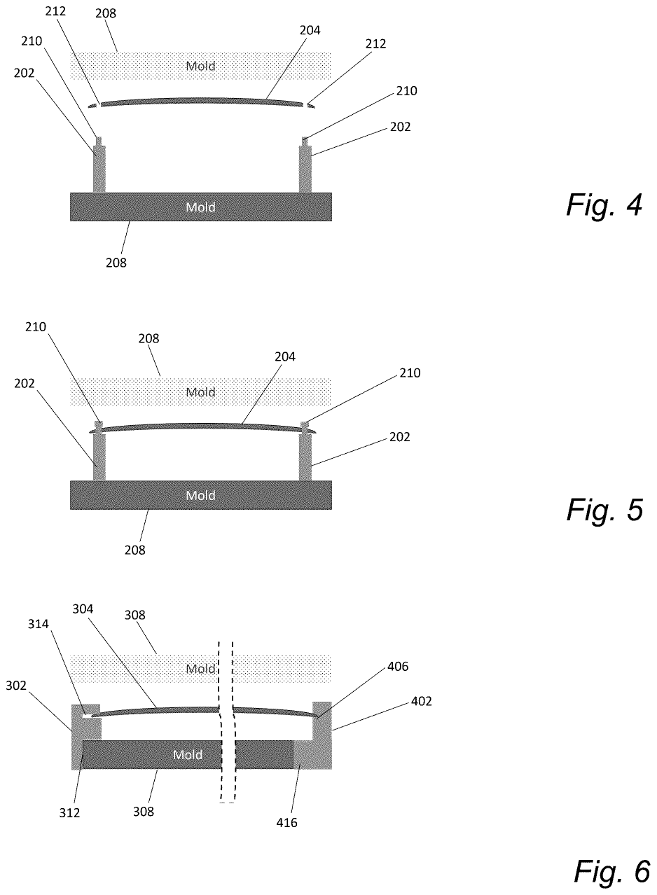

In a further embodiment, shown in FIGS. 4 and 5, the spacers 202 are first attached to the mould 208 and then the foil 204 is introduced onto the spacers 202. In this embodiment, the spacers 202 include protrusions 210 that are received into corresponding holes 212 in the foil 204. Once the foil 204 has been received onto the spacers 202, the foil 204 is secured by heating to soften or melt the spacers 202 such that the protrusions 210 of the spacers 202 may be deformed to secure the foil 204 in position. In similar embodiments, rather than securing the foil by deforming the end, i.e., the protrusions, of the spacer, additional material may be added. For example, adhesive may be applied onto the spacer and foil, or a screw or other attachment means may be utilized.

A further embodiment utilizes more massive spacers 302, 402, shown in FIG. 6. The spacers 302, 402 in this embodiment resemble a ring. In this arrangement, the spacers 302, 402 therefore are seated around the mould 308 rather than be attached thereto. The spacers 302, 402 are therefore shaped to receive the mould 308, in order to hold the mould 308 in the desired position. FIG. 6 shows two different possibilities for how the mould 308 could be held by the spacers 302, 402.

On the left side, a recess 312 is formed in the spacer 302, into which the mould 308 is seated. A second recess 314 is also formed in the spacer 302 in order to receive the foil 304. As with previous embodiments, the order in which the foil 304 and mould 308 are introduced to the spacer 302 is not imperative. The mould 308 and foil 304 may further be secured by additional means, as mentioned in relation to previous embodiments.

On the right side, the spacer 402 abuts the mould 308, using an abutment 416. Although the abutment 416 is shown as a lateral protrusion from the spacer 402, the abutment 416 may instead be the same width as the remainder of the spacer 402 and therefore need not protrude. The contact of the abutment 416 with the mould 308 ensures that the mould 308 is maintained in the desired position relative to the spacer 402. The foil 304, meanwhile, is received within a small notch 406, similarly to FIG. 1, rather than into the large recess 314 shown on the left side of FIG. 6.

As noted above, whilst each embodiment here discusses the use of a foil with a spacer, the foil may be replaced with any other object, such as a lens, a thin display, a hologram, a logo, or other similar such objects, and therefore the use of the term “foil” in the specific description is not intended to be limiting to the invention as a whole.

As will be clear to the skilled person, any method or arrangement for locating the mould in any embodiment may be combined with any method or arrangement for locating the spacer, and the specific arrangements are not limited to the combinations disclosed herein.

1. A method of spacing an object from a mould, for the formation of a multi-layered polymer, comprising:
attaching at least one spacer to the object;
attaching the at least one spacer to the mould; and
adding material to the mould to form the multi-layered polymer.

2. The method of claim 1, wherein the object comprises one of a foil, a lens, a display, or other similar object.

3. The method of claim 1, wherein the object is received with one or more notches or recesses in the at least one spacer.

4. The method of claim 1, wherein the at least on spacer includes a protrusion onto which the object is received.

5. The method of claim 4, wherein the object is secured to the at least one spacer by deforming the protrusion once the object is received on the at least on spacer.

6. The method of claim 1, wherein the object is secured to the at least one spacer, for example by adhesive, spot welding, a fastening device, or other such means.

7. The method of claim 1, wherein the at least one spacer is secured to the mould, for example by adhesive, spot welding, a fastening device, or other such means.

8. The method of claim 1, wherein the step of curing the monomer is achieved by the application of UV radiation or by a thermal curing process.

9. The method of claim 1, further comprising the step of removing the at least one spacer after curing the monomer.

10. The method of claim 1, wherein the at least one spacer is seated around the mould.

11. The method of claim 1, wherein the at least one spacer is retained as a part of the multi-layer polymer.

12. The method of claim 11, wherein the at least one spacer includes a recess or abutment into or against which the mould is received.
